(19) United States
(12) Patent Application Publication
(10) Pub. No.: US 2019/0114640 A1
(43) Pub. Date: Apr. 18, 2019

(54) SYSTEMS AND METHODS FOR DETECTING PERIODIC PATTERNS IN LARGE DATASETS

(71) Applicant: FIS Financial Compliance Solutions, LLC, Jacksonville, FL (US)

(72) Inventors: MARK A. RUBIN, Woburn, MA (US); Stanley Tam, Quincy, MA (US); Minghai Li, Winchester, MA (US)

(73) Assignee: FIS Financial Compliance Solutions, LLC, Jacksonville, FL (US)

(21) Appl. No.: 16/164,760

(22) Filed: Oct. 18, 2018

Related U.S. Application Data
(60) Provisional application No. 62/573,989, filed on Oct. 18, 2017.

(51) Int. Cl. G06Q 20/40; G06F 11/34; G06F 11/30; G06F 9/54; G06K 9/62

(52) U.S. Cl. CPC G06Q 20/4016; G06F 11/3495; G06F 11/3075; G06F 9/542; G06F 2201/81; G06K 9/627; G06F 2201/86; G06F 2201/875; G06K 9/6223

(57) ABSTRACT

The present disclosure relates to systems, methods, and computer readable media for detecting periodic sequences of events. A computer-implemented method may include collecting processing times and values associated with each of a plurality of events. The method may also include assigning each of the plurality of events to at least one of a plurality of time phases, the plurality of time phases forming a period characteristic of the plurality of events. The method may also include grouping the events in each of the plurality of time phases into one or more clusters, based on the respective values associated with the events. The method may also include determining a periodic sequence of events based on the one or more clusters. The method may further include recording the periodic sequence of events in a database of periodic sequences.

### RELATED APPLICATIONS

This application claims priority to U.S. Provisional Patent Application No. 62/573,989, filed on Oct. 18, 2017, the entire disclosure of which is incorporated by reference in the present application.

### TECHNICAL FIELD

The present disclosure generally relates to computerized methods and systems for detecting periodic patterns in large datasets and, more particularly, related to computerized methods and systems for extracting periodic events from large datasets and detecting fraud based on the periodic events.

### BACKGROUND

In data mining, outlier detection refers to the identification of data points which do not conform to an expected pattern or other data points in a data set. When the data points represent real-world events, the presence of data outliers may be a sign of some kind of problem, such as a fraud (e.g., credit card fraud, insurance fraud, etc.), a structural failure of a building, a health problem, a cyber-security breach, etc. Thus, outlier detection finds extensive use in a wide variety of applications.

For example, a user account may have both periodic and non-periodic payments. Periodic payments generally may represent non-discretionary spending, while non-periodic payments generally may represent discretionary spending. Mortgages, car payments, utility payments, and alimony payments are examples of periodic payments.

Periodic payments may be described by periodic sequences of check payments, i.e., sequences of checks which arrive at roughly (though not necessarily exactly) regular time intervals, e.g., weekly or monthly, with roughly (though not necessarily exactly) identical dollar amounts.

Deviation from a periodic sequence of events can be a sign that an account has been compromised or is under a fraud attack. For example, a fraudster who has compromised a victim's on-line account can see the previous payments made from the account. The fraudster may attempt to make an illicit payment whose dollar amount mimics that of a periodic payment, assuming that the illicit payment will go unnoticed because payments of the similar or same amount have occurred before. However, the illicit payment breaks the victim's valid payment pattern. Thus, financial crimes could be detected by monitoring deviations from periodic or regular payments.

Aided by automated tools proliferating in the current computer age, financial frauds are rising and have become more sophisticated, faster, and harder to detect. Therefore, there is a pressing need to quickly and accurately detect the criminal activities embedded in massive datasets spanning years and decades. Existing fraud detecting software requires constantly tuning parameters and close human supervision, e.g., eye spotting false positives, and manual review of individual accounts. Existing fraud detecting software cannot adequately handle easily handle massive datasets spanning a long period of time to spot suspicious activities quickly due to the need for human supervision and constant parameter tuning.

### SUMMARY

The inventors recognized that to detect payments deviating from periodic sequences of payments, it is necessary to first know what are the existing periodic sequences of check payments. Accordingly, the inventors developed computerized methods and systems capable of quickly and accurately detecting periodic events in large data sets without the need for human supervision or constant parameter tuning.

The disclosed embodiments are directed to computerized methods and systems for detecting patterns of periodic events from a large set of data. For illustrative purposes only, exemplary embodiments are described using periodic payments, e.g., check payments on a regular basis and with similar currency amounts, as an example.

Various examples may include, but are not limited to, computer-implemented methods, systems, and computer program products for detecting and responding to fraudulent activity based on determined periodic sequences of events. For example, a computer-implemented method may include collecting processing times and values associated with each of a plurality of events. The method may also include assigning each of the plurality of events to at least one of a plurality of time phases, the plurality of time phases forming a period characteristic of the plurality of events. The method may also include grouping the events in each of the plurality of time phases into one or more clusters, according to the respective values associated with the events. The method may also include determining a periodic sequence of events based on the one or more clusters. The method may further include recording the periodic sequence of events in a database of periodic sequence.

The disclosed embodiments include a computerized method for detecting periodic sequences of payments. The method may include collecting processing times and currency amounts associated with a plurality of payments. The method may also include assigning each of the plurality of payments to at least one of a plurality of time phases, the plurality of time phases forming a period characteristic of the plurality of payments. The method may further include grouping the payments in each of the plurality of time phases into one or more clusters, according to the currency amounts of the payments, where the one or more clusters represent potential periodic sequences of payments.

The disclosed embodiments include a system for detecting periodic sequences of payments. The system may include a memory storing instructions. The system may also include one or more hardware processors that execute the instructions to: collect processing times and currency amounts associated with a plurality of payments; assign each of the plurality of payments to at least one of a plurality of time phases, the plurality of time phases forming a period characteristic of the plurality of payments; and group the payments in each of the plurality of time phases into one or more clusters, according to the currency amounts of the payments, where the one or more clusters represent potential periodic sequences of payments.

The disclosed embodiments also include a non-transitory computer-readable storage medium for detecting periodic sequences of payments. The medium may include instructions that, when executed by at least one hardware processor, causes the at least one processor to collect processing times and currency amounts associated with a plurality of payments; assign each of the plurality of payments to at least one of a plurality of time phases, the plurality of time phases forming a period characteristic of the plurality of payments; and group the payments in each of the plurality of time phases into one or more clusters, according to the currency amounts of the payments, where the one or more clusters represent potential periodic sequences of payments.

### BRIEF DESCRIPTION OF THE DRAWINGS

FIG. 1 is a block diagram of an exemplary system for detecting periodic sequences of payments, consistent with the disclosed embodiments.

FIG. 2 is a block diagram of a user terminal used in the system shown in FIG. 1, consistent with the disclosed embodiments

FIG. 3 is a block diagram of a server used in the system shown in FIG. 1, consistent with the disclosed embodiments.

FIG. 4 is a flowchart of an exemplary method for quantifying the evidence for periodic sequences of check payments, consistent with the disclosed embodiments.

FIG. 5 is a schematic diagram illustrating a process for updating payments assigned into a time phase, consistent with the disclosed embodiments.

FIG. 6 is a flowchart of an exemplary method for clustering payments assigned to a time phase by currency amounts of the payments, consistent with the disclosed embodiments.

FIG. 7 is a flowchart of an exemplary method for determining the number of actual periodic sequences of payments present in a plurality of payments, consistent with the disclosed embodiments.

FIG. 8 is a flowchart of an exemplary method for generating a reminder for making a periodic payment, consistent with the disclosed embodiments.

FIG. 9 is a flowchart of an exemplary method for detecting fraud based on periodic events, consistent with the disclosed embodiments.

### DETAILED DESCRIPTION

The disclosed embodiments include systems, methods, and computer program products for detecting fraudulent activity deviating from one or more determined periodic events identified within a dataset. For illustrative purpose only, the following description assumes the periodic events are payments received and processed by a financial institution, e.g., check payments. However, it is contemplated that the periodic events can be any type of financial transactions, such as cash withdrawals, stock (or future, option, commodity, etc.) trading, purchase payments made at a grocery store, bill payments, etc. Moreover, it will be appreciated by those skilled in the art that the principles and embodiments of the present disclosure can be readily applied to the detection of fraudulent activity based on periodic events identified within structured and/or unstructured datasets, including in technical areas beyond financial technology, e.g., computer systems, computer networks, computer security, Internet-based applications and services, detecting periodic traces left in network traffics by malware and/or denial-of-service attacks, detecting and separating periodic and/or quasi-periodic pulse trains generated by different radar sources.

Before explaining certain embodiments of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the accompanying drawings and Appendices, are for the purpose of description and should not be regarded as limiting.

As such, those skilled in the art will appreciate that the conception upon which this disclosure is based may readily be utilized as a basis for designing other structures, methods, and systems for carrying out the several purposes of the present disclosure.

Reference will now be made in detail to the present exemplary embodiments of the disclosure, examples of which are illustrated in the accompanying drawings. Wherever possible, the same reference numbers will be used throughout the drawings to refer to the same or like parts.

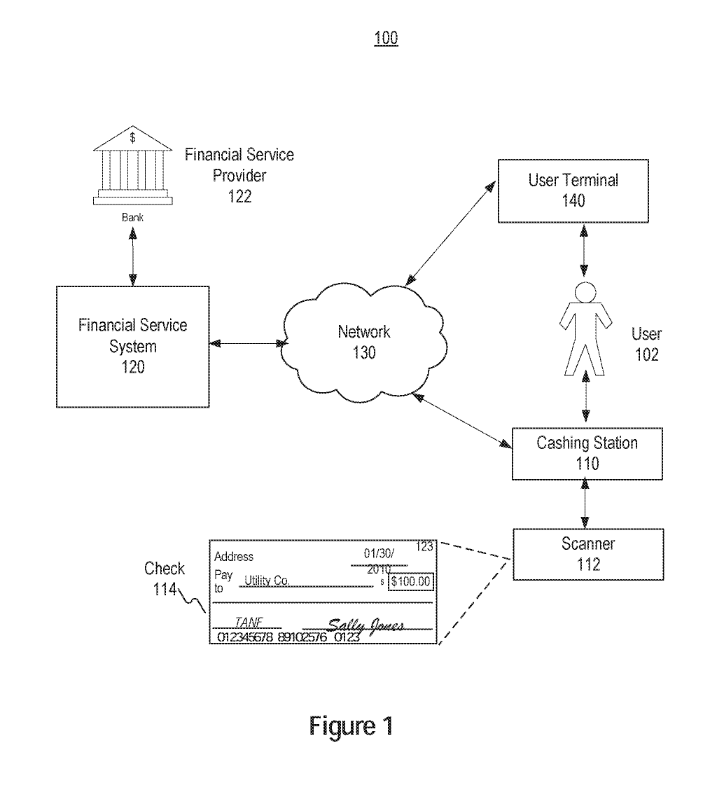

FIG. 1 is a schematic diagram illustrating a system 100 for detecting periodic sequences of payments, consistent with the disclosed embodiments. For example, the payments processed by system 100 may be in the form of check payments, debit card payments, credit card payments, electronic payment made through the Automated Clearing House (ACH) Network, Real-Time Payment Network, wire transfers, electronic payments, peer-to-peer payments, etc. Moreover, the payments processed by system 100 may include periodic payments, such as payments of utility bills, providing paychecks to an employee through direct deposits, mortgage payments, etc. As shown in FIG. 1, system 100 may include one or more of a cashing machine 110, a scanner device 112, a financial service system 120, a network 130, a user terminal 140, etc. System 100 may be used to analyze payment activities in an account owned by a user 102. For example, in some embodiments, system 100 may be used to process a check 114 made from user 102's account and determine whether the payment associated with check 114, along with many other payments made from the account, form a periodic payment sequence. Of course, as evident by the following description, the application of system 100 is not limited to check payments. Rather, the disclosed systems and methods are intended to accommodate any forms of payment, including digital or electronic payments, such as payment made using a mobile application (e.g., Apple Wallet®) or an electronic fund transfer application (Zelle®). As one of ordinary skill will understand, in some embodiments, various ones of the elements in FIG. 1 may be duplicated, substituted, combined, or omitted.

Cashing station 110 may be implemented as a computer or other electronic device operable to accept paper or electronic checks and/or payments from user 102. In some embodiments, cashing station 110 may be implemented as a point-of-sale (POS) device operable to receive payment information for purchases and check information for deposits. In other embodiments, cashing station 110 may be implemented as an attended machine (e.g., by a cashier or clerk) or an automated kiosk (e.g., by user 102 actuating a screen or buttons to deposit the check) operable to receive check information for deposits. In other embodiments, cashing station 110 may be implemented as a personal computer, online terminal, or mobile device operating a software application configured to capture check information, including, among other things, a check image. And, in yet other embodiments, cashing station 110 may be a retail point-of-sale device, automated teller machine (ATM), e-commerce website, or mobile application configured to receive checking account information. In such embodiments a physical check may not be present, but rather user 102 may provide payment account information (or information that may be used to detect such checking account) to effect an electronic payment for goods or services.

Cashing station 110 may be connected (e.g., via a wired connection, mobile network, or wireless connection, such as network 130) to scanner 112. Scanner 112, in some embodiments, may be implemented as an image-based check scanner, a Magnetic Ink Character Recognition (MICR) check scanner, or the like, and may be configured to scan a check (such as check 114) in order to determine the data printed or written on the front and/or back sides of the check. Consistent the disclosed embodiments, scanner 112 may also be implemented as a camera, such as an embedded mobile camera within a mobile device, which is used to capture an image of a check. Scanner 112 may then send this data to cashing station 110, and cashing station 110 may assemble a check cashing or payment request to send to other devices, such as financial service system 120.

Check 114 is an exemplary financial instrument such as typical paper checks used in the United States. For example, check 114 may be any of a payroll check, a government check (e.g., welfare), an insurance check, a financial dividend check, a cashier's check, a money order, a two-party personal check (e.g. a check endorsed by two parties for deposit by one of them), a government-issued tax refund check, a privately-issued tax refund check, a RAL (Refund Anticipation Loan) check, a rebate check, or the like.

Financial service system 120 may be one or more computer systems associated with one or more entities, such as a financial service provider 122. Consistent with the present disclosure, financial service system 120 may be configured to determine periodic sequences present in the payments made by user 102. In the disclosed embodiments, financial service system 120 may be owned and/or directly operated by financial service provider 122 to determine the periodic sequences. Alternatively, financial service system 120 may be developed and operated by a third-party service provider who is authorized by financial service provider 122 to determine the periodic sequences and report the determination result to financial service provider 122.

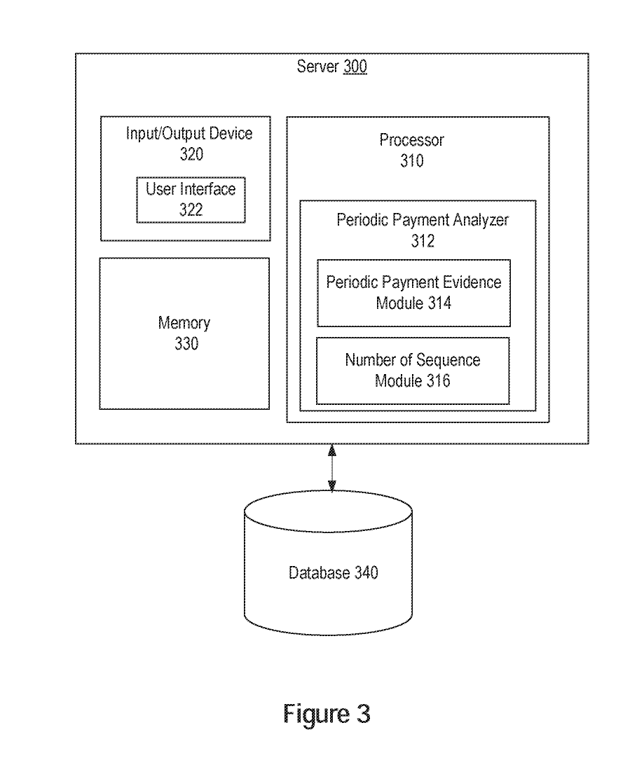

Financial service system 120 may include one or more components that perform processes consistent with the disclosed embodiments. For example, financial service system 120 may include one or more computers (e.g., servers, database systems, etc.) configured to execute software instructions programmed to perform aspects of the disclosed embodiments, such as collecting data regarding check payments, clustering the payments by times when the payments arrive at a bank and/or currency amounts associated with the payments, searching for a number of periodic sequences in the payments, etc. Details about the operations of financial service system 120 are described below in connection with server 300 (FIG. 3).

Financial service provider 122 may be an entity that provides financial services. For example, financial service provider 122 may be a bank, a check clearing house, or other type of financial service entity that configures, offers, provides, and/or manages financial service accounts, such as checking accounts, savings accounts, debit card accounts, etc. These financial service accounts may be used by user 102 to purchase goods and/or services, pay bills, etc. In some embodiments, financial service provider 122 may include or be associated with financial service system 120, which may be configured to perform one or more aspects of the disclosed embodiments.

Network 130 may be any type of network that facilitates communications and data transfer between cashing station 110 and financial service system 120. Network 130 may be a Local Area Network (LAN), a Wide Area Network (WAN), such as the Internet, and may be a single network or a combination of networks. Further, network 130 may reflect a single type of network or a combination of different types of networks, such as the Internet and public exchange networks for wireline and/or wireless communications. Network 130 may utilize cloud computing technologies that are familiar in the marketplace, and allow one or more components, devices, and/or computer systems to operate in a distributed cloud environment. Network 130 is not limited to the above examples and system 100 may implement any type of network that allows the entities (shown and not shown) included in FIG. 1 to exchange data and information.

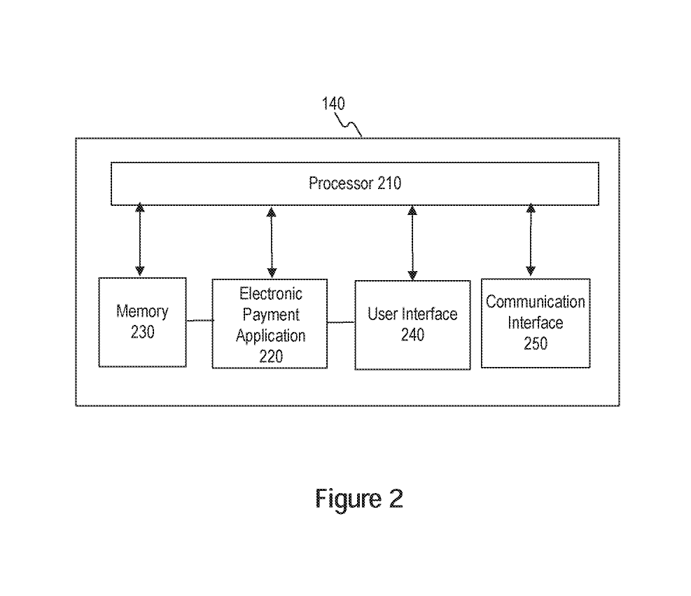

Consistent with the disclosed embodiments, the payments may also be paid by user 102 in an electronic form. For example, user 102 may initiate an electronic payment using user terminal 140. For example, user terminal 140 may be installed with applications such as Apple Wallet® or Zelle®, which can be used to initiate a payment or fund transfer. FIG. 2 is a block diagram of user terminal 140, consistent with disclosed embodiments. User terminal 140 may be a mobile phone, a personal computer, a wearable device (e.g., a smart watch, smart glasses, etc.), a digital broadcast terminal, a messaging device, a gaming console, a tablet computer, a medical device, exercise equipment, a personal digital assistant, and the like. As shown in FIG. 2, user terminal 140 may include one or more hardware processor(s) 210, an electronic payment application 220, a memory 230, a user interface 240, and a communication interface 250.

Processor 210 may include a digital signal processor, a microprocessor, or other appropriate processor to facilitate execution of computer instructions encoded in a computer-readable medium. Processor 210 may be configured as a separate processor module dedicated to making an electronic payment. Alternatively, processor 210 may be configured as a shared processor module for performing other functions of user terminal 140 unrelated to the disclosed methods for making an electronic payment. In the exemplary embodiments, processor 210 may execute computer instructions (program code) stored in memory module 230, and may perform functions in accordance with exemplary techniques described in this disclosure.

Memory 230 may include any appropriate type of mass storage provided to store information that processor 210 may need to operate. Memory 230 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 230 may be configured to store one or more computer programs that may be executed by processor 210 to perform the disclosed functions for making an electronic payment.

Electronic payment application 220 may be a module dedicated to performing functions related to initiating an electronic payment. Electronic payment application 220 may be configured as hardware, software, or a combination thereof. For example, electronic payment application 220 may be implemented as computer code stored in memory 230 and executable by processor 210. As another example, electronic payment application 220 may be implemented as a special-purpose processor, such as an application-specific integrated circuit (ASIC), dedicated for making an electronic payment. As yet another example, electronic payment application 220 may be implemented as an embedded system or firmware, and/or as part of a specialized computing device.

User interface 240 may include a display panel. The display panel may include a liquid crystal display (LCD), a light-emitting diode (LED), a plasma display, a projection, or any other type of display, and may also include microphones, speakers, and/or audio input/outputs (e.g., headphone jacks).

User interface 240 may also be configured to receive input or commands from user 102. For example, the display panel may be implemented as a touch screen to receive input signals from the user. The touch screen includes one or more touch sensors to sense touches, swipes, and other gestures on the touch screen. The touch sensors may not only sense a boundary of a touch or swipe action, but also sense a period of time and a pressure associated with the touch or swipe action. Alternatively or in addition, user interface 240 may include other input devices such as keyboards, buttons, joysticks, and/or tracker balls. User interface 240 may be configured to send the user input to processor 210 and/or electronic payment application 220.

Communication interface 250 can access a wireless network 130 based on one or more communication standards, such as WiFi, LTE, 2G, 3G, 4G, 5G, etc. In one exemplary embodiment, communication interface 250 may include a near field communication (NFC) module to facilitate short-range communications between user terminal 140 and other devices. In other embodiments, communication interface 250 may be implemented based on a radio-frequency identification (RFID) technology, an infrared data association (IrDA) technology, an ultra-wideband (UWB) technology, a Bluetooth® technology, or other technologies.

Consistent with the disclosed embodiments, user 102 may use user terminal 140 to initiate an electronic payment. For example, in one embodiment, processor 210 or electronic payment application 220 may display, on user interface 240, a virtual check having dialog boxes for entry of a printed parsed MICR number. This number is broken down into two components: a routing and transit number (“RTN”) or financial institution specific number, and a checking account number. To allow for ease of entry, the dialog boxes on the virtual check may appear in a location representative of the placement of that information on a paper check. Remaining information that typically needs to be entered on a paper check such as the user's name and address, payee, and currency amount may also be input by user 102 via user interface 240 or pre-stored in memory 230. When all necessary additional information is entered, processor 210 may compile the data from the entry screens into a data stream, which is sent by communication interface 250 to financial service system 120 for processing.

After receiving the data stream, financial service system 120 may authenticate the payment information included in the data stream and authorize the payment. If the payment is authorized, financial service system 120 sends a message to an Automated Clearing House (ACH). The message includes information converted from the electronic check into an ACH format. The ACH sends a message to user 102's bank (e.g., financial service provider 122) to collect or withdraw funds from user 102's bank account. The ACH also sends an electronic message to the payee's bank, causing payment to be deposited into the payee's bank account.

As described above, financial service system 120 may include one or more servers for detecting periodic sequences present in the payments made by user 102. FIG. 3 is a block diagram of a server 300 for detecting periodic sequences, consistent with disclosed embodiments. In an exemplary embodiment, financial service system 120 may include server 300. Server 300 may be one or more computing devices configured to execute software instructions stored in memory to perform one or more processes consistent with the disclosed embodiments. For example, server 300 may include one or more memory devices storing data and software instructions and one or more hardware processors 310 configured to use the data and execute the software instructions to perform server-based functions and operations known to those skilled in the art. Server 300 may be configured to execute stored software instructions to detect periodic sequences of payments associated with a user account, in a manner consistent with the disclosed embodiments.

In one embodiment, server 300 may include one or more processors 310, one or more input/output (I/O) devices 320, and one or more memories 330. Server 300 may be standalone, or it may be part of a subsystem, which may be part of a larger system. For example, server 300 may represent distributed servers that are remotely located and communicate over a network (e.g., network 130) or a dedicated network, such as a LAN.

Processor 310 includes or is part of one or more known processing devices such as, for example, a microprocessor. In some embodiments, processor 310 includes any type of single or multi-core processor, mobile device microcontroller, central processing unit, etc. In operation, processor 310 executes computer instructions (program code) and performs functions in accordance with techniques described herein. Computer instructions include routines, programs, objects, components, data structures, procedures, modules, and functions, which perform particular functions described herein. Consistent with the disclosed embodiments, processor 310 may include a Periodic Payment Analyzer 312 configured to detect periodic sequences of payments based on historical data associated with a bank account. In some embodiments, Periodic Payment Analyzer 312 may further include one or both of a Periodic Payment Evidence (PPE) module 314 and a Number of Sequences (NoS) module 316. In other embodiments, PPE module 314 and/or NoS module 316 may be implemented separately from Periodic Payment Analyzer 312. The operations of PPE module 314 and NoS module 316 are described in more detail below in connection with the method embodiments.

I/O devices 320 may be one or more devices configured to allow data to be received and/or transmitted by server 300. I/O devices 320 may include one or more user I/O devices and/or components, such as those associated with a keyboard, mouse, touchscreen, display, etc. I/O devices 320 may also include one or more digital and/or analog communication devices that allow server 300 to communicate with other machines and devices, such as other components of system 100. I/O devices 320 may also include interface hardware configured to receive input information and/or display or otherwise provide output information. For example, I/O devices 320 may include a monitor configured to display a user interface of periodic payment analyzer 312, which can present the results of the detected periodic sequences of payments.

Memory 330 may include one or more storage devices configured to store instructions used by processor 310 to perform functions related to the disclosed embodiments. For example, memory 330 may be configured with one or more software instructions associated with programs and/or data. Memory 330 may include a single program that performs the functions of the server 300, or multiple programs. Additionally, processor 310 may execute one or more programs located remotely from server 300. Memory 330 may also store data that may reflect any type of information in any format that the system may use to perform operations consistent with the disclosed embodiments.

Server 300 may also be communicatively connected to one or more database(s) 340. For example, server 300 may be communicatively connected to database 340 through network 330. Database 340 may include one or more memory devices that store information and are accessed and/or managed through server 300. By way of example, database 340 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, server 300 may include database 340. Alternatively, database 340 may be located remotely from the server 300. Database 340 may include computing components (e.g., database management system, database server, etc.) configured to receive and process requests for data stored in memory devices of database 340 and to provide data from database 340.

In an example, one indication of risk of fraud for in the payment requests received by financial service system 110 is deviation from periodic sequences of payment present in historical data. Periodic sequences of payments are sequences of payment request (e.g., checks to be cashed, ACH requests, etc.) which arrive at roughly—though not necessarily exactly—regular time intervals, e.g., weekly or monthly, with roughly—though not necessarily exactly—identical dollar amounts. To identify payment requests which deviate from periodic sequences of payment, an exemplary method may identify periodic sequences that are present in the historical data.

In the disclosed embodiment, Periodic Payment Analyzer 312 may be configured to identify the periodic sequences present in historical data of payments. In particular, Periodic Payment Analyzer 312 may first quantify the “evidence,” i.e., information from the payments, for detecting the presence of potential periodic sequences of payments. Then, Periodic Payment Analyzer 312 may further examine the potential periodic sequences of payments to determine whether some or all of the potential periodic sequences correspond to actual periodic payments.

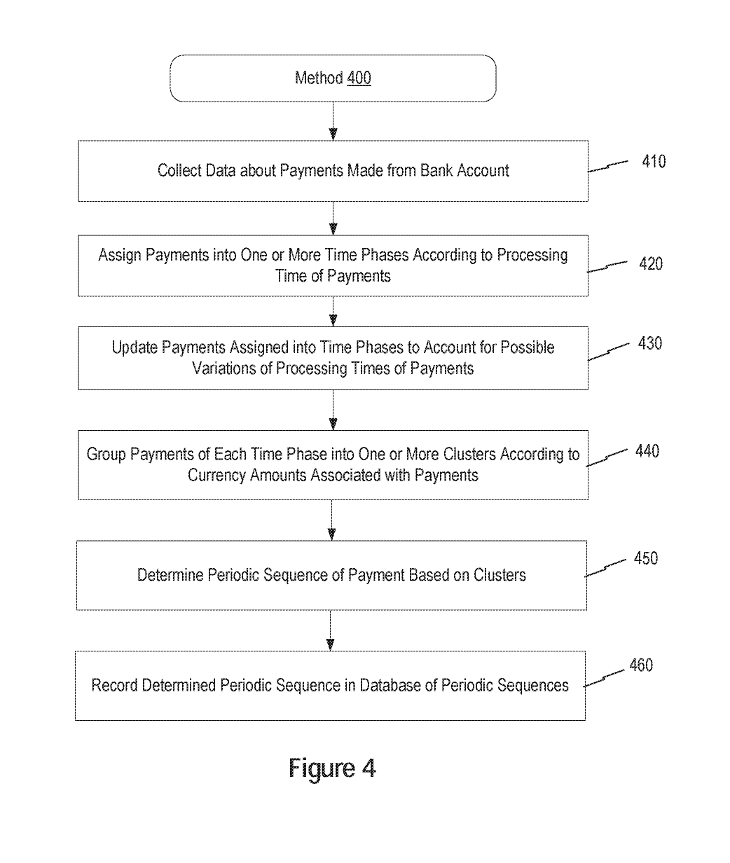

FIG. 4 is a flowchart of an exemplary method 400 for quantifying the evidence for periodic sequences of payments, consistent with the disclosed embodiments. For example, method 400 may be performed by PPE module 314. In some embodiments, the payments may be check payments fulfilled by paper checks or electronic checks, or otherwise electronic payments. Referring to FIG. 4, method 400 may include the following steps.

In step 410, PPE module 314 collects data about payments made from a bank account. The payment data may include the processing time of the payments, e.g., the timing that financial service provider 122 receives requests for initiating the payments, e.g., the time at which a check or a request for initiating an electronic payment arrives at or is received by financial service provider 122. The payment data may also include currency amounts associated with the payments. For example, the collected data may include the arrival time of a check to the check's issuing bank and the currency or payment amount (e.g., dollar amount) shown on the check. PPE module 314 may collect the data in various ways. For example, PPE module 314 may receive the data directly from cashing station 110 and/or user terminal 140. Alternatively or additionally, PPE module 314 may retrieve the data from database 340.

In step 420, PPE module 314 assigns the payments into one or more time phases according to the processing time of the payments. Specifically, the payments may be associated with certain financial periods or cycles. For example, checks paying rent may be made once a month while the checks paying for groceries may be made once a week. A period under consideration (e.g., a week or a month) may be divided into to a plurality of time phases (hereinafter also referred to as phases). For example, a week can be divided into Monday, Tuesday, . . . , and Sunday, i.e., 7 phases. As another example, a month can be divided into 31 days (i.e., 31 phases) or 30 days (i.e., 30 phases).

PPE module 314 may create a “bin” for each time phase. That is, for each period (e.g., a week or a month), there is a number of bins equal to the number of phases included in that period. If the period is a week, the number of phase bins is 7 (checks can come in on Monday, Tuesday, . . . , and Sunday). If the period is a month, the number of phase bins is 31 (checks can come in on the 1st, 2nd, . . . , and 31st days of a month) or 30. PPE module 314 may record each check under consideration in at least one phase bin. In some embodiments, if the monthly period is divided into 30 bins, payments processed on the 31st day of a month can be recorded in the 30th bin.

For example, if a check of $1100 arrives on a Monday, which is also the 10th of the month, PPE module 314 may record the check in a weekly bin for Monday, and in a monthly bin for the 10th day of the month. In addition, if a second check of $1100 arrives on Monday, the 17th of the month, PPE module 314 may record the second check in the weekly bin for Monday, and in a monthly bin for the 17th day of the month. Accordingly, the weekly-Monday contains the list ($1100, $1100), the monthly-10th bin contains ($1100), and the monthly-17th bin contains ($1100).

In step 430, PPE module 314 updates the payments assigned into the time phases to account for the possible variations of the processing times of the payments. In reality, a periodic check payment may not always come in the same day of a week or month. Rather, there may be some variations to the checks' arrival time (i.e., time at which a check arrives the check's issuing bank). For example, rent checks typically arrive in a bank on the 3rd of a month, but occasionally on the 2nd or 4th of a month. To account for this variation, PPE module 314 may update the payments assigned into a phase bin by including payments recorded in neighboring phases.

For example, if before the update, bins weekly-Saturday, weekly-Sunday, and weekly-Monday include check payments ($500), ($500, $1000), and ($1000, $750), respectively, PPE module 314 may update the weekly-Sunday bin by including the check payments from the weekly-Saturday and weekly-Monday bins as well as the weekly-Sunday bin. In this example, after the update, the weekly-Sunday bin contains ($500, $1000, $500, $1000, $750). Other weekly bins can be updated in a similar manner.

In other words, PPE module 314 may assign the payments originally recorded in a first phase (i.e., a first bin) to neighboring phases in one or both directions (i.e., phases preceding and/or succeeding the first phase), without removing the original payments from the first phase. This is to account for the possibility that the payments originally recorded in a first phase might actually be part of the periodic payments occurring on one or more of the neighboring phases. The neighboring phases may be phases that are immediately adjacent to the first phase or phases separate from the first phase by a predetermined number of phases. In some embodiments, PPE module 314 may assign evidence (i.e., payments) from bins of two days away in one or both directions to the first phase. For weekly bins, assigning evidence from bins two days away to the first bin may be a limit, because a week only has seven days. In contrast, for monthly bins, PPE module 314 may assign evidence from bins of more than two days away in one or both directions to the first bin.

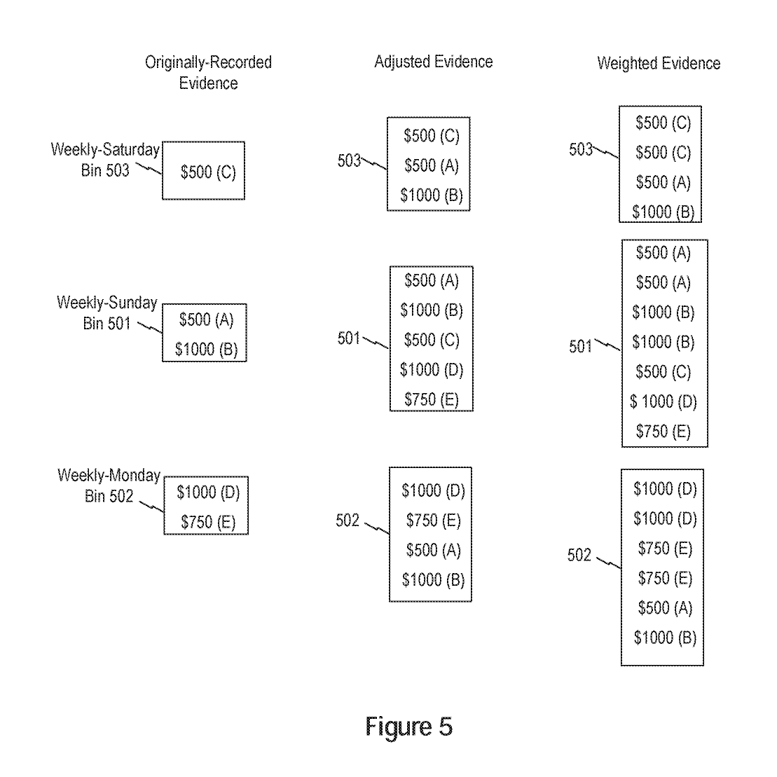

Moreover, in some embodiments, PPE module 314 may assign more weight to evidence that is originally assigned to a bin. For example, in addition to a first payment originally recorded for a bin, PPE module 314 may add a predetermined number of payments having the same currency amount as the first payment to the bin, such that the original recorded payment(s) get more representation in the bin. For instance, FIG. 5 shows weekly bin for Sunday (501) and immediately adjacent (neighboring) bins Saturday (503) and Monday (502). As shown in FIG. 5, the payments originally recorded for the weekly-Sunday bin are ($500, $1000). These payments are labeled A and B, respectively for illustrative purposes. To account for possible variation of the timing when the payments are made, PPE module 314 may add the payments originally recorded for the weekly-Saturday bin ($500 (C)) and the weekly-Monday bin ($1000 (D), $750 (E)), such that the updated weekly-Sunday bin contains ($500 (A), $1000 (B), $500 (C), $1000 (D), $750 (E)) shown in FIG. 5 as Adjusted Evidence. Further, PPE module 314 may give more weight to the payment(s) originally recorded for the weekly-Sunday bin by adding additional counts of the originally-recorded evidence $500 (A), $1000(B), shown as Weighted Evidence in FIG. 5. After the weight adjustment and weighting, the weekly-Sunday bin contains ($500 (A), $500 (A), $1000 (B), $1000 (B), $750 (E), $500 (C), $1000 (D)). In some embodiments, the weighting may be higher than the doubling shown in the Weighted Evidence of FIG. 5.

In step 440, PPE module 314 groups the payments of each time phase into one or more clusters according to the currency amounts associated with the payments. Specifically, PPE module 314 may group the check payments of each phase into one or more clusters using any suitable clustering algorithm, such as a K-means clustering algorithm. The mean of the currency amounts in each cluster of a given phase bin sets the currency amount of a periodic sequence of check payments at the phase, and the number of check payments in each cluster specifies the evidence for the existence of a corresponding sequence. For example, if one of the clusters in the bin weekly-Tuesday has a mean of $76.52 and has 79 check payments, this indicates there is evidence at a level of 79 for a weekly payment of about $76.52 being made on Tuesdays.

Consistent with the disclosed embodiments, the clustering algorithm can be set to make fewer clusters with larger spreads of amounts in each cluster, or more clusters with smaller spreads of amounts in each cluster. For example, PPE module 314 may set a maximum cluster size, i.e., a distance from the mean of the cluster to any member of the cluster, to be 5% of the mean. This way, periodic payments with larger mean dollar amounts have more tolerance to variation in the magnitudes of the payments.

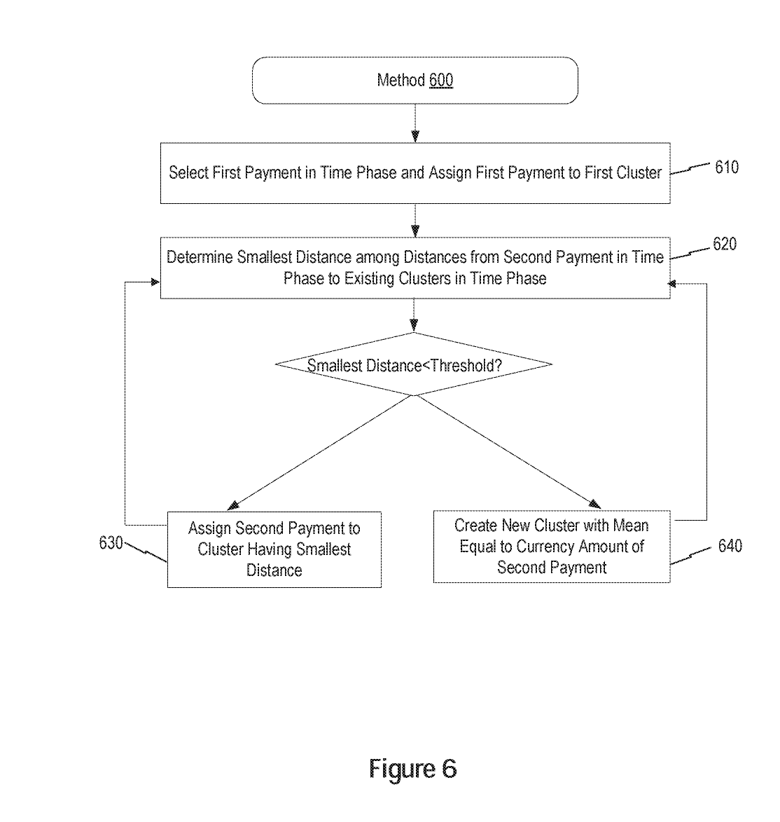

FIG. 6 is a flowchart of an exemplary method 600 for clustering payments assigned to a time phase by currency amounts of the payments, consistent with the disclosed embodiments. For example, FIG. 6 may be performed by PPE module 314. Referring to FIG. 6, method 600 includes the following steps.

In step 610, when no cluster has been formed for payments assigned to a time phase, PPE module 314 randomly selects a first payment in the time phase and assigns the first payment to a first cluster.

In step 620, PPE module 314 determines a smallest distance among distances from a second payment in the time phase to existing clusters in the time phase. The distance between the second payment and a cluster is a mathematical difference between the currency amount of the second payment and the currency amount associated with the center of the cluster. When the time phase only has one existing cluster, the distance between the second payment and the one existing cluster is considered as the smallest distance.

In step 630, when the smallest distance is below a certain threshold distance, PPE module 314 assigns the second payment to the cluster having the smallest distance. PPE module 314 may then update the mean of the cluster having the smallest distance, by including the currency amount of the second payment. PPE module 314 may also increase the number of payments assigned to the cluster by 1. In some embodiments, PPE module 314 may set the threshold distance to be a predetermined percentage of the mean of the cluster having the smallest distance to the second payment.

In step 640, when the smallest distance is above or equal to the threshold distance, PPE module 314 creates a new cluster with a mean equal to the currency amount of the second payment, and sets the number of payments in the new cluster to be 1. Consistent with the disclosed embodiments, steps 620-640 may be repeated until all the payments assigned to the time phase are assigned to respective clusters.

Referring back to FIG. 4, in step 450, Periodic payment Analyzer 312 determines one or more periodic sequences of payments based on the clusters. The clusters formed according to 600 indicate potential periodic sequences of payments. In some embodiments, if it is known that a certain number N of periodic sequences is typical, then the N sequences to which PPE module 314 assigns the most evidence, the most payments, are taken to be the periodic sequences of check payments.

If, however, the number N is not known, NoS module 316 may be employed to search for the number of periodic sequences of check payments based on the evidence generated by PPE module 314. Specifically, NoS module 316 determines how many of the periodic sequences (clusters) to which PPE 314 has assigned evidence should be considered as periodic sequences that are actually present in the underlying data.

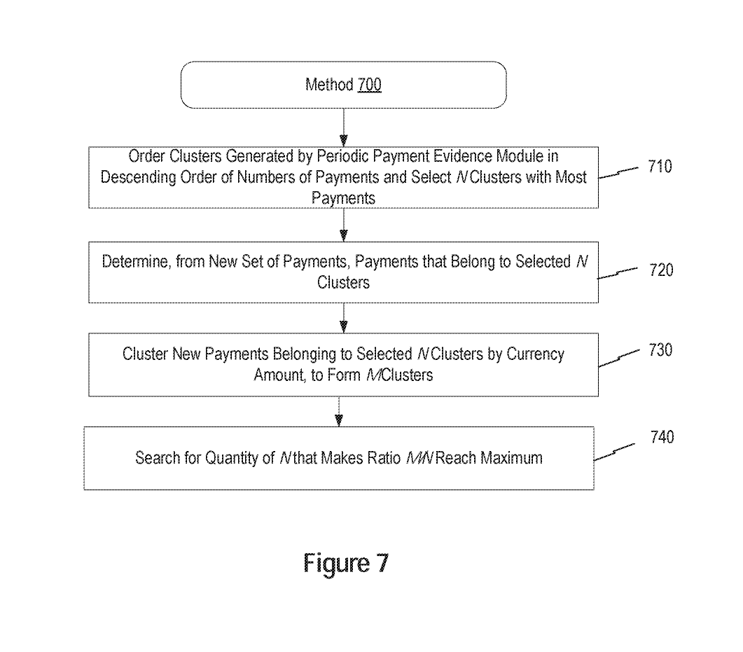

FIG. 7 is a flowchart of an exemplary method 700 for determining the number of actual periodic sequences of payments present in a plurality of payments, consistent with the disclosed embodiments. For example, FIG. 7 may be performed by NoS module 316. Referring to FIG. 7, method 700 includes the following steps.

In step 710, NoS module 316 orders the clusters generated by PPE 314 in a descending order of numbers of payments assigned to these clusters and selects N clusters with the most payments. Each of the N clusters is described by at least three parameters: time phase (or “bin”) to which the cluster belongs, number of payment in the cluster, and currency amount associated with the cluster (i.e., the mean of the currency amounts of all the payments in the cluster).

As described above, the clusters generated by PPE 314 may correspond to weekly patterns, monthly patterns, or other types of patterns (e.g., semi-monthly). Thus, for example, among the selected N clusters, some of them may correspond to monthly patterns, and some of them may correspond to weekly patterns. For a fixed period, such a year, the number of payments belonging to a weekly pattern is usually higher than the number of payments belonging to a monthly pattern. This is because one year has roughly 52 weeks, but only 12 months. In some embodiments, before selecting the N clusters from the clustering result generated by PPE 314, NoS module 316 may multiple the numbers of payments in clusters corresponding to monthly patterns by a rescale factor 52/12, to take into account the fact that over a given yearly period a weekly sequence of periodic payments may have 52/12 as many payments as a monthly sequence.

In step 720, NoS module 316 determines, from a new set of payments, payments that belong to the selected N clusters. The new set of payments are different from the payments used by PPE 314. NoS module 316 may determine that a new payment belongs to one of the selected N clusters if the new payment has the same time phase as the cluster and has a currency amount falling in the size of cluster (i.e., with a predetermined vicinity surrounding the mean of the cluster).

In step 730, NoS module 316 clusters the new payments belonging to the selected N clusters by the currency amounts of these new payments, to form M clusters. NoS module 316 may use a clustering method similar to method 600.

In step 740, NoS module 316 searches for a quantity of N that makes the ratio M/N reaches a maximum. Specifically, NoS module 316 may repeat steps 710-730 with different quantities for N. As N increases, M may also increase. However, after N increases beyond a certain number, M will not increase as fast as N, because the newly included payments may not actually constitute a new periodic sequence of payments. If M/N reaches a maximum when N=Nₚ, NoS module 316 may determine that the number of actual periodic sequences of payments present in the plurality of payments is Nₚ.

In some embodiments, PPE module 314 and/or NoS module 316 may employ machine-learning algorithms to optimize the parameters used in performing methods 400, 600, and 700, such as parameters used in dividing a period into different time phases, assigning payments to the time phrases, and clustering the payments. The machine-learning algorithms may be supervised or unsupervised.

Referring back to FIG. 4, in step 460, Periodic payment Analyzer 312 records the determined periodic sequences of payments in a database of periodic sequences. For example, the database of periodic sequences may be a part or the whole of database 340. The recorded periodic sequences of payments may be used for various purposes. For example, upon receiving a user command for retrieving a recorded periodic sequence, processor 310 may display parameters of the recorded sequence (e.g., time phase, average currency amount of payments belonging to the sequence) on user interface 322, such that a user can verify whether the sequence is an actually occurring sequence.

In the exemplary embodiments, after sequences of periodic events are detected, the disclosed system may also detect an omission of a periodic events. For example, system 100 may have a “bill pay reminder” function that, based on the sequences of periodic payments present in the historical datasets detected by Periodic Payment Analyzer 312, system 100 may further determine that user 102 has missed a periodic payment and system 100 may send an alert to user 102. Additionally, system 100 may send a reminder to user 102 prior to an expected periodic payment, for example, by predicting one or more periodic payments in advance based on the systems and methods described in the present disclosure.

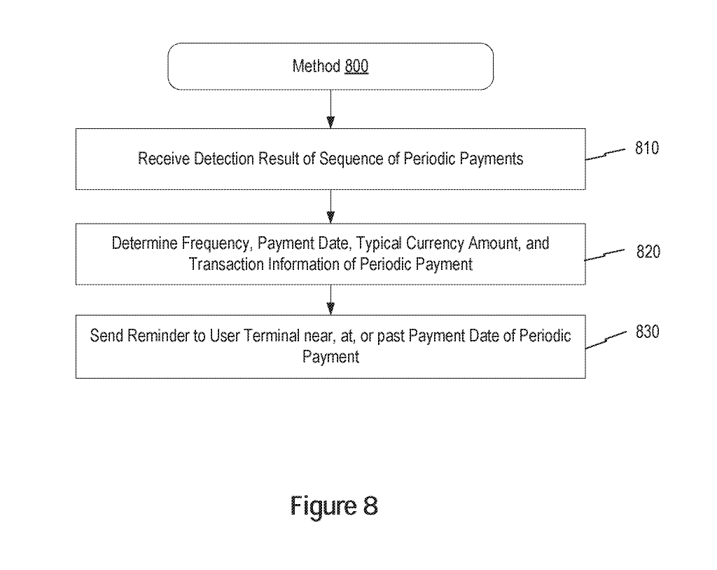

FIG. 8 is a flowchart of an exemplary method 800 for generating a reminder for making a periodic payment, consistent with the disclosed embodiments. For example, method 800 may be performed by system 100. Referring to FIG. 8, method 800 may include the following steps.

In step 810, processor 310 receives an output of Periodic Payment Analyzer 312, indicating a sequence of periodic payments.

In step 820, processor 310 determines a frequency, a payment date, a typical currency amount, and transaction information of the periodic payment. The frequency, payment date, and currency amount are indicated by the time phase and currency amount associated with the sequence of periodic payment Periodic Payment Analyzer 312. For example, the periodic payment may be a monthly mortgage payment of $2500, occurring on the 15th day of a month—thus, the frequency is monthly, payment date is the 15th, and typical currency amount is $2,500. As another example, the periodic payment may be a weekly payroll check of $1000 to an employee, occurring on every Tuesday. There, the frequency is weekly, payment date is Tuesday, and typical currency amount is $1000. As yet another example, the periodic payment may be a weekly grocery spending with an average amount of $80, occurring in every weekend (i.e., Saturday or Sunday). There, the frequency is weekly, payment date is Saturday (or Sunday, system 100 may select one of the two or alternate between the two), and the typical currency amount is $80. The transaction information includes information such as payee of the payment, purpose of the payment, etc., e.g., the employee's name and that the purpose is payroll in one of the forgoing examples.

In step 830, processor 310 sends a reminder to user terminal 140 near, at, or past a payment date of the periodic payment. For example, processor 310 may send a reminder to user terminal 140 before each scheduled periodic payment. As another example, processor 310 may constantly monitor user 102's account and, if a periodic payment is past due, send an alert to user terminal 140. Such features may be optional or fixed and may optionally be configured by the user interface 240 to the user's preferences.

In the exemplary embodiments, after a sequence of periodic events is detected, the disclosed system may also be used to detect whether a newly occurred event deviates from or is an outlier of the sequence of periodic events. Such deviation or outlier information may be used to assess risks that the newly occurred events is associated with a fraud. For example, system 100 may be configured to determine whether a newly received payment request deviates from a previously detected periodic payment and determine whether the newly received payment request could be a fraud based on the deviation.

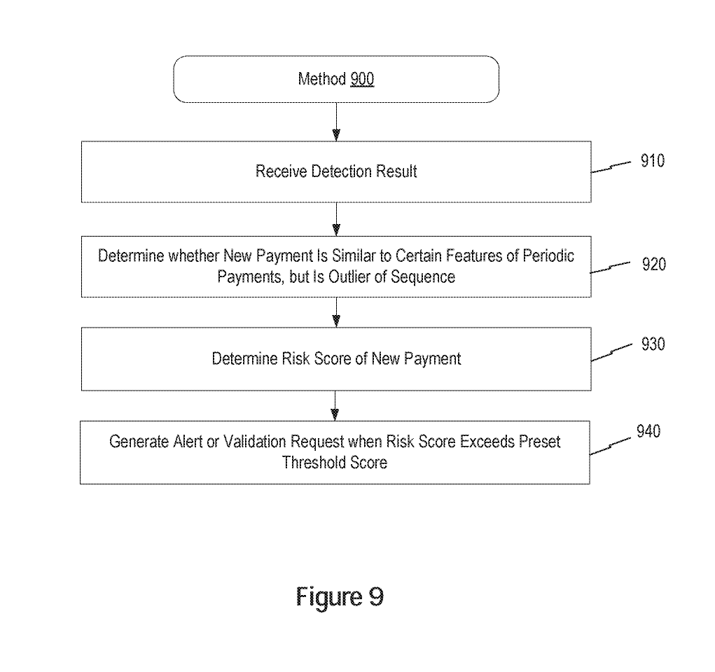

FIG. 9 is a flowchart of an exemplary method 900 for detecting fraud based on periodic events, consistent with the disclosed embodiments. For example, the periodic events may be a sequence of periodic payments, and method 900 may be performed by system 100. Referring to FIG. 9, method 900 may include the following steps.

In step 910, processor 310 receives an output of Periodic Payment Analyzer 312, indicating a sequence of periodic payments.

In step 920, processor 310 determines whether a new payment is similar to certain features of the periodic payments, but is an outlier of the sequence. In particular, the new payment may have a currency amount similar to the currency amount characteristic of the periodic payments, but falls outside the periodicity of the sequence of periodic payments. For example, the new payment may deviates from the periodicity because it falls on a day different from a time phase characteristic of the periodic payments (e.g., a new payment of $2000 is similar to a monthly rent payment that has a characteristic currency amount of $2000 and normally occurs during the first 3 days of a month, but the new payment of $2000 was made on the 15th day of the month). As another example, the new payment may deviate from the periodicity because it deviates from the frequency of the periodic payments (e.g., a weekly payment with a characteristic currency amount of $250 is detected for a bank account, but a payment of $247 and a payment of $252 were recently made from the bank account within the same week).

In step 930, processor 310 determines a risk score of the new payment. The risk score indicates the possibility for the new payment to be associated with a fraud. Processor 310 may determine the risk score based on the new payment's time-phase variance, currency-amount variance, and/or frequency variance from the sequence of periodic payments. For example, the risk score may be proportional to the difference between the new payment's time phrase and the time phase characteristic of the sequence of periodic payments.

In step 940, processor 310 generates an alert or validation request when the risk score exceeds a preset threshold score. In particular, processor 310 may send a fraud alert to user terminal 140, to draw user 102's attention to the new payment. Processor 310 may also send a second-factor authentication or multi-factor authentication request (e.g., request for input of both a password and biometric data, such as fingerprint or face image) to user terminal 140, for user 102 to validate the new payment. Processor 310 may also record the new payment as a security exception or security event for further processing by financial service system 120 or review by financial service provider 122. Processor 310 may also perform a security-related event with the user 102's account, such as locking the account or partially restricting usage of the account (e.g., limiting certain functionality of an account in an application, only allowing transactions below a certain threshold amount, only allowing use of the account from a trusted location such as a home or office, etc.) or putting the new payment on hold until the new payment is validated by user 102 and/or approved by financial service provvider 122

Another aspect of the disclosure is directed to a non-transitory computer-readable medium storing instructions which, when executed, cause one or more processors to perform the disclosed methods. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed systems and related methods. Other embodiments will be apparent to those skilled in the art from consideration of the specification and practice of the disclosed systems and methods. It is intended that the specification and examples be considered as exemplary only, with a true scope being indicated by the following claims and their equivalents.

What is claimed is:

1. A computer system, comprising:
a memory storing instructions; and
a hardware processor configured to execute the instructions to:
collect processing times and values associated with a plurality of events;
assign each of the plurality of events to at least one of a plurality of time phases forming a period characteristic of the plurality of events;
group the events in each of the plurality of time phases into one or more clusters based on the values of the events;
determine a periodic sequence of events based on the one or more clusters; and
record the periodic sequence of events in a database of periodic sequences.

2. The computer system of claim 1, wherein the hardware processor is further configured to:
select N clusters having the most events;
determine, from a set of new events, events that belong to one of the N clusters;
cluster the new events belonging to the N clusters by value, to form M clusters;
determine a quantity, Nₚ, for N where M/N reaches a maximum; and
determine that the plurality of events include Nₚ actual periodic sequences of events.

3. A computer-implemented method, comprising:
collecting, by one or more hardware processors, processing times and values associated with a plurality of events;
assigning, by one or more of the hardware processors, each of the plurality of events to at least one of a plurality of time phases forming a period characteristic of the plurality of events;
grouping, by one or more of the hardware processors, the events in each of the plurality of time phases into one or more clusters based on the values of the events;
determining a periodic sequence of events based on the one or more clusters; and
recording the periodic sequence of events in a database of periodic sequences.

4. The computer-implemented method of claim 3, wherein each of the plurality of time phases correspond respectively to days that form a weekly period.

5. The computer-implemented method of claim 3, wherein each of the plurality of time phases correspond respectively to days that form a monthly period.

6. The computer-implemented method of claim 3, wherein assigning each of the plurality of events to at least one of a plurality of time phases comprises:
assigning a first event to a first time phase matching a processing time of the first event.

7. The computer-implemented method of claim 6, further comprising:
assigning the first payment to a neighboring time phase of the first time phase.

8. The computer-implemented method of claim 7, wherein the neighboring time phase is at least one of a time phase adjacent to the first time phase or a time phase separate from the first time phase by a predetermined number of time phases.

9. The computer-implemented method of claim 6, wherein:
the first event is a first payment having a value comprising a first currency amount; and
the method further comprises in addition to the first payment, adding a predetermined number of payments with the first currency amount to the first time phase.

10. The computer-implemented method of claim 3, wherein:
the plurality of time phases include a first time phase, and the events in the first time phase include a first event with a first value; and
grouping the events in each of the plurality of time phases into one or more clusters comprises:
determining a smallest distance among distances from the first event to one or more existing clusters in the first time phase;
when the smallest distance is below a threshold distance, assigning the first event to the cluster having the smallest distance, and updating, based on the first value, a mean of the cluster having the smallest distance;
when the smallest distance is above or equal to the threshold distance, generate a new cluster with a mean equal to the first value.

11. The computer-implemented method of claim 10, further comprising:
setting the threshold distance to be a predetermined percentage of the mean of the cluster having the smallest distance.

12. The computer-implemented method of claim 10, further comprising:
when there is no existing cluster in the first time phase, generating a new cluster with a mean equal to the first value.

13. The computer-implemented method of claim 10, further comprising:
setting a size of each of the one or more clusters to be proportional to a mean of the cluster.

14. The computer-implemented method of claim 3, wherein grouping the events in each of the plurality of time phases into one or more clusters comprises:
using a K-means clustering method to group the events into the one or more clusters.

15. The computer-implemented method of claim 3, further comprising:
when it is known that the plurality of events include N periodic sequences of events; determining N clusters having the most events represent the N periodic sequences of events, respectively.

16. The computer-implemented method of claim 3, further comprising:
selecting N clusters having the most events;
determining, from a set of new events, events that belong to one of the N clusters;
clustering the new events belonging to the N clusters by value, to form M clusters;
determining a quantity, Nₚ, for N where M/N reaches a maximum; and
determining that the plurality of events include N ₚ actual periodic sequences of events.

17. The computer-implemented method of claim 3, further comprising transmitting, to a terminal, a reminder for an event in the periodic sequence of event.

18. The computer-implemented method of claim 3, further comprising determining a level of deviation of a new event from the periodic sequence of events.

19. The computer-implemented method of claim 3, further comprising
when level of deviation exceeds a threshold level, generating a fraud alert or transmitting a request for validating the new event to a terminal.

20. A non-transitory computer-readable storage medium comprising instructions that, when executed by at least one hardware processor, causes the at least one processor to:
collect processing times and values associated with a plurality of events;
assign each of the plurality of events to at least one of a plurality of time phases forming a period characteristic of the plurality of events;
group the events in each of the plurality of time phases into one or more clusters;
determine a periodic sequence of events based on the one or more clusters; and
record the periodic sequence of events in a database of periodic sequences.
